(19) United States
(12) Patent Application Publication
(10) Pub. No.: US 2004/0101448 A1
(43) Pub. Date: May 27, 2004

(54) Reactor for producing hydrofluorocarbon compound

(75) Inventors: Iikubo Yuichi, West Lafayette, IN (US); Hae-Seok Ji, Ulsan (KR); Ook-Jae Cho, Ulsan (KR)

Correspondence Address: John S. Egbert, Harrison & Egbert, 7th Floor, 412 Main Street, Houston, TX, 77002, US

(73) Assignee: ULSAN CHEMICAL Co., Ltd., Ulsan (KR)

(21) Appl. No.: 10/372,433

(22) Filed: Feb. 24, 2003

(30) Foreign Application Priority Data
Nov. 21, 2002 (KR) 2002-72667

(51) Int. Cl. B01J 10/00

(52) U.S. Cl. 422/129; 422/241

(57) ABSTRACT

Disclosed is a reactor for producing a hydrofluorocarbon compound by reacting a chlorinated organic compound with hydrogen fluoride in liquid phase in the presence of an antimony chlorofluoride catalyst, comprising an inner wall B lined with a polytetrafluoroethylene (PTFE) resin, and an outer wall A. A space G of 2 to 10 mm is formed between the inner wall and the outer wall, and maintained by spiral baffles. Additionally, a plurality of vent holes with diameter of 2 to 5 mm are formed, at regular intervals of 150 to 300 mm, on the whole inner wall of the reactor. The reactor is advantageous in that the PTFE resin lined on the inner wall of the reactor is not degraded, thereby prolonging a reactor's life span and easily supplying heat to the reactor.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention pertains to a reactor for producing a hydrofluorocarbon compound.

### BACKGROUND OF THE INVENTION

As well known to those skilled in the art, chlorofluorocarbon-based compounds conventionally used as foaming agents, abluents, aerosol propellants, and coolants, are known as materials with high ozone-depleting potential which destroy the ozone layer in the stratosphere, and so have been replaced with hydrochlorofluorocarbon (hereinafter, referred to sometimes as “HCFC”). However, recently, HCFC based materials are prone to be replaced with hydrofluorocarbon (hereinafter, referred to sometimes as “HFC”) compounds, without ozone-depleting potential, because HCFC-based materials still have ozone depleting potential, even though its value is low.

HFC compounds are produced by reacting a chlorinated organic compound, defined by following Formula I, with hydrogen fluoride (HF) in liquid phase or gas phase, in the presence of an antimony chlorofluoride catalyst (SbClₓF_{y}, wherein x+y=5, 1≦y≦5):

CₙHₘFₓCl_{y} Formula I

wherein, n is 1 to 3, m is 1 to 7, x is 0 to 7, y is 1 to 8, and m+n+y≦2n+2.

In the case of producing the HFC compound according to a conventional gas phase method, it is difficult to desirably control reaction conditions because of the high reaction temperature, and byproducts are produced in great quantities to reduce yield of the HFC compound, thereby lowering reaction efficiency in comparison with a conventional liquid phase method. As for the conventional liquid phase method, reactants in liquid phase come in contact with a reactor under high temperature and pressure to seriously corrode the metal reactor, thus shortening a reactor's lifespan. Efforts to solve the above disadvantages have been made, in which the concentration of a catalyst is reduced or the reactor is made of a corrosion-resistant metal, but the above disadvantage has not been completely solved. Therefore, a reactor, an inner surface of which is lined with fluorine resin (polytetrafluoroethylene, hereinafter referred to sometimes as “PTFE”) is used to prevent corrosion of the reactor.

However, the reactor lined with the PTFE resin is disadvantageous in that a separate heat supplying unit is necessary because of its having lower thermal conductivity than the metal reactor, and a portion of reactants, mostly consisting of hydrogen fluoride, flows throughout the PTFE resin layer into an interval between the PTFE resin layer and a reactor wall because of high reaction pressure. As described above, when flowing into the interval between the PTFE resin layer and the reactor wall, hydrogen fluoride forms a predetermined pressure in the interval to cause the PTFE resin layer to swell in a form of bubble and expand. In this case, reactants easily come in contact with the reactor wall to corrode the reactor wall, thereby easily leaking reactants from the reactor. The reason for this is that the PTFE resin layer is strongly attached to the reactor wall because of high reaction pressure (6 atm. or higher), so a pathway between the resin layer and the reactor wall for normally moving hydrogen fluoride penetrating throughout the PTFE resin layer is blocked, thus not smoothly emitting hydrogen fluoride to a desired place. Because reactants such as hydrogen fluoride are poisonous, if reactants are emitted from the reactor to the atmosphere, workers are exposed to a dangerous environment.

In order to effectively remove reactants comprising hydrogen fluoride from the interval between the resin layer and the reactor wall, a structure has been proposed, in which vent holes are formed on the reactor wall and hydrogen fluoride is vacuum-sucked through the vent holes. But this structure does not clearly prevent reactants from being emitted to the atmosphere.

Accordingly, there remains a need to develop a reactor for producing a HFC based compound according to a liquid phase method, which easily supplies heat to the reactor, prolongs a reactor's life span, and secures safety of the working environment.

### BRIEF SUMMARY OF THE INVENTION

Therefore, it is an object of the present invention to provide a reactor for producing a hydrofluorocarbon based compound by reacting a chlorinated organic compound with hydrogen fluoride in liquid phase in the presence of an antimony halide catalyst, which has advantages of easy heat supply and a prolonged life span of the reactor.

The present inventors have conducted extensive studies into the reactor, made of metals and lined with PTFE resin on an inner wall thereof, for producing hydrofluorocarbon based compounds, resulting in the finding that heat is readily supplied to the reactor and a reactor's life span is prolonged by forming a space of 2 to 10 mm between the PTFE resin-lined inner wall and an outer wall of the reactor, circulating heated raw material in the space, and feeding a portion of circulated raw material as a reactant into the reactor, thereby accomplishing the present invention.

### BRIEF DESCRIPTION OF THE SEVERAL VIEWS OF THE DRAWINGS

The above and other objects, features and other advantages of the present invention will be more clearly understood from the following detailed description taken in conjunction with the accompanying drawings, in which:

FIG. 1 is a circuit diagram of a system of producing a hydrofluorocarbon compound using a reactor according to the present invention; and

FIG. 2 is an enlarged sectional view of a portion R of FIG. 1.

### DETAILED DESCRIPTION OF THE INVENTION

The present invention relates to a reactor for producing a hydrofluorocarbon compound by reacting a chlorinated organic compound with HF in liquid phase in the presence of an antimony halide catalyst.

As well known to those skilled in the art, reactants actively corrode a metal reactor in a liquid phase reaction in which the chlorinated organic compound is reacted with HF. A low concentration of catalyst may be used to prevent corrosion of the metal reactor, but this does not completely prevent corrosion of the reactor.

According to the present invention, the reactor is structured in such a way that an inner wall of the reactor lined with a PTFE resin layer is positioned at a distance of about 2 to 10 mm from an outer wall of the reactor. The heated chlorinated organic compound is fed into a space formed between the inner wall and the outer wall to dilute hydrogen fluoride emitting throughout the PTFE resin layer into the space. Additionally, the heated chlorinated organic compound circulating in the space functions to supply heat to the reactor, thereby desirably producing the HFC compound.

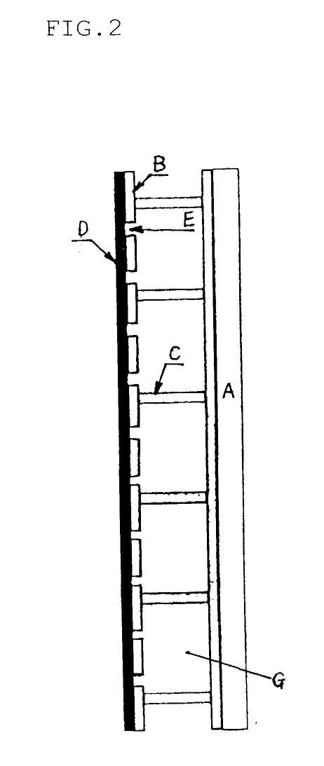

With reference to FIG. 2, the inner wall B of the metal reactor is lined with a PTFE resin D, and rod-shaped spiral baffles C are arranged, at regular intervals of 50 to 300 mm, in a space G between the inner wall and the outer wall so as to position the inner wall B at a distance of about 2 to 10 mm from the outer wall A of the reactor. Additionally, vent holes E with diameters of 2 to 5 mm are positioned at regular intervals of 150 to 300 mm on the whole inner wall B, and the PTFE resin D is lined on an inside of the inner wall. Accordingly, hydrogen fluoride penetrating throughout the PTFE resin D flows through the vent holes E into the space G between the inner wall and the outer wall of the reactor.

Furthermore, while circulating in the space G of the reactor wall under lower pressure than an inside of the reactor, the heated chlorinated organic compound functions to supply heat required in a liquid phase reaction to the reactor and dilute hydrogen fluoride emitted from the reactor into the space G. Gas in the space G between the inner wall B and outer wall A of the reactor is the nearly pure chlorinated organic compound, thus safely performing the liquid phase reaction without bubbling or softening of the PTFE resin D. Because the vent holes E are densely positioned on the whole inner wall B of the reactor, hydrogen fluoride is readily mixed with the circulating chlorinated organic compound and diluted. Additionally, the PTFE resin is lined on the inner wall of the reactor using a minimum amount of adhesive according to a loose lining process in which the resin D is loosely attached to the inner wall B of the reactor by applying vacuum pressure of 300 mmHg through the vent holes E to the resin, thus securing a narrow space between the resin D and the inner wall B of the reactor. At this time, hydrogen fluoride penetrating throughout the resin D remains in the narrow space, thereby readily coming in contact with the raw material circulating in the space G between the inner wall and the outer wall of the reactor.

When a hydrofluorocarbon based compound such as difluoromethane (CH₂F₂, hereinafter referred to as “HFC-32”) is produced according to a liquid phase method, heat should be continuously supplied from an external heat source to the reactor so as to obtain sufficient reaction heat. However, it is difficult to obtain sufficient heat required to produce HFC based compounds using only an external jacket because the reactor lined with the PTFE resin has very low thermal conductivity. Thus, it is necessary to feed additional heated raw material other than raw material consumed in a production reaction of the HFC based compound to the reactor. For this reason, a separate heat supplying device is needed.

According to the present invention, the heat is desirably supplied to the reactor by circulating the heated chlorinated organic compound used as raw material in the space G of the reactor wall, re-heating the raw material flowing out the space G, and re-circulating the heated raw material in the space G. At this time, a portion of the chlorinated organic compound is fed into the reactor to participate in reacting with hydrogen fluoride. The chlorinated organic compound is continuously supplemented from a raw material supplying tank to the space G of the reactor. As described above, the chlorinated organic compound circulating in the space G between the inner wall and the outer wall of the reactor functions to wash hydrogen fluoride emitting throughout the resin layer D into the space G and supply heat to the reactor. In other words, the present invention is characterized in that the raw material is circulated in the space G of the reactor so as to obtain heat required to produce the HFC based compound by reacting the chlorinated organic compound with hydrogen fluoride in the presence of the antimony catalyst. Because a small amount of hydrogen fluoride penetrating throughout the resin layer is diluted by the chlorinated organic compound circulating in the space G and the chlorinated organic compound used in a production reaction of the HFC based compound is continuously supplemented from the external raw material supplying tank, a concentration of hydrogen fluoride in a feed is very low.

As described above, when the chlorinated organic compound is reacted with hydrogen fluoride in the reactor lined with the PTFE resin, the heated chlorinated organic compound is fed from the external raw material supplying tank to the reactor so as to supply sufficient heat to the production reaction of the HFC based compound. In the case of producing difluoromethane (CH₂F₂, HFC-32), a reaction temperature is 50 to 150° C., preferably 60 to 100° C., and a reaction pressure is 6 to 18 kg/cm², preferably 6 to 13 kg/cm². At this time, raw material, dichloromethane (CH₂Cl₂, hereinafter referred to as “HCC-30”) exists in the space G of the reactor, and the space G is lower than an inside of the reactor in terms of pressure by 3 to 10 kg/cm². Additionally, pressures of the space and the inside of the reactor are easily controlled. It is important to maintain pressure in the reactor higher than that in the space G so that the lined fluorine resin is closely attached to the inner wall of the reactor.

A better understanding of the present invention may be obtained in light of the following examples which are set forth to illustrate, but are not to be construed to limit the present invention.

### EXAMPLE

As shown in FIG. 2, an inner wall B of the reactor is positioned at an interval of about 2 to 10 mm from an outer wall A of the reactor, and lined with PTFE resin. Rod-shaped spiral baffles C, being capable of enduring reaction pressure, are arranged, at regular intervals of 50 to 300 mm, in a space G between the inner wall B and the outer wall A of the reactor. Additionally, vent holes E with diameters of about 5 mm are formed at regular intervals of 150 to 300 mm on the whole inner wall of the reactor, and the PTFE resin D is lined on an inside of the inner wall.

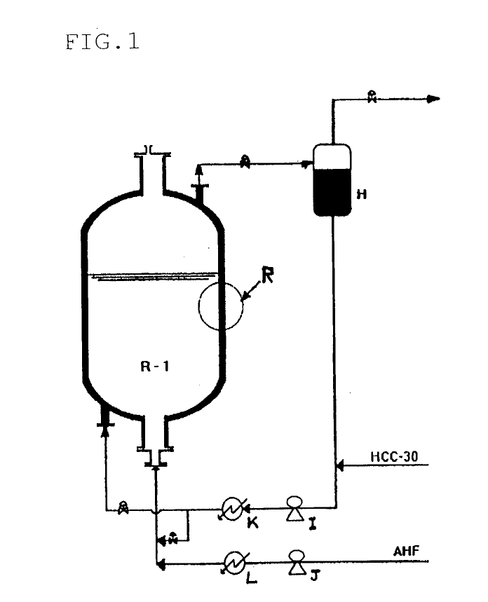

In the case of producing HFC-32, raw material (HCC-30) was heated by a first heat exchanger K to 80 to 150° C. and then fed into the space G of the reactor, as shown in FIG. 1. HCC-30 flowing out the space G of the reactor was re-heated to 80 to 150° C. and re-fed into the space G of the reactor by a pump I. A portion of HCC-30 circulating in the space G was mixed with hydrogen fluoride heated by a second heat exchanger L at a lower part of the reactor R₁, fed into the reactor, and then reacted in the presence of a fluorinated antimony catalyst. A reaction temperature was 60 to 100° C. and reaction pressure was 6 to 13 kg/cm², and the reaction temperature was controlled by adjusting the amount of HCC-30 circulating in the space G. A portion of HCC-30 circulating in the space G was used as a reactant, and HCC-30 was continuously supplied from the raw material supplying tank to the space G. Pressure in the space G was lower than that in the reactor by 3 to 10 kg/cm². A molar ratio of HCC-30 circulating in the space G to HCC-30 used as the reactant was 10:1 to 300:1. Thereby, a production reaction of HFC-32 was desirably performed without additionally feeding the heated reactant to the reactor and without a separate heat supplying unit.

During the production reaction of HFC-32, the reactor was scarcely corroded, hydrogen fluoride penetrating from the inside of the reactor through the PTFE resin to the space G of the reactor was not accumulated between the PTFE resin and the reactor wall, and leakage of the raw material due to bubbling of the PTFE resin did not occur. In particular, heated HCC-30 was fed into the space G of the reactor, thereby easily supplying heat to the reactor.

As described above, a reactor according to the present invention is advantageous in that PTFE resin lined on an inner wall of the reactor is not degraded, thereby prolonging a reactor's life span and easily supplying heat to the reactor.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

We claim:

1. A reactor for producing a hydrofluorocarbon compound by reacting a chlorinated organic compound with hydrogen fluoride in liquid phase in a presence of an antimony chlorofluoride catalyst, comprising:
an inner wall lined with a polytetrafluoroethylene resin;
an outer wall positioned outside said inner wall with a space of 2 to 10 mm defined between the inner wall and the outer wall, and a plurality of spiral baffles arranged in said space to maintain the space; and
a plurality of vent holes with diameter of 2 to 5 mm, said vent holes being formed, at regular intervals of 150 to 300 mm, on an entire area of the inner wall of the reactor.

2. The reactor according to claim 1, wherein the chlorinated organic compound is defined by following Formula I:
CₙHₘFₓCl_{y} Formula I
wherein, n is 1 to 3, m is 1 to 7, x is 0 to 7, y is 1 to 8, and m+n+y≦2n+2.
